(19) United States
(12) Patent Application Publication
(10) Pub. No.: US 2010/0249008 A1
(43) Pub. Date: Sep. 30, 2010

(54) Cleaning Agent

(76) Inventors: Thomas Holderbaum, Hilden (DE); Nadine Warkotsch, Dusseldorf (DE)

Correspondence Address: Henkel Corporation, 10 Finderne Avenue, Suite B, Bridgewater, NJ, 08807, US

(21) Appl. No.: 12/795,840

(22) Filed: Jun. 8, 2010

Related U.S. Application Data
(63) Continuation of application No. PCT/EP08/64807, filed on Oct. 13, 2008.

(30) Foreign Application Priority Data
Dec. 10, 2007 (DE) 10 2007 059 677.6

(51) Int. Cl. C11D 17/00

(52) U.S. Cl. 510/224

(57) ABSTRACT

One- or two-phase dishwasher tablets produced of a compacted, particulate material, wherein at least one tablet phase A comprises, based on its total weight, a) 5 to 50% by weight of citrate, b) 1 to 20% by weight of citric acid, c) 0.1 to 40% by weight of anionic polymer(s) comprising i) acid group-containing monomers, ii) other nonionic monomers. The dishwasher tablets according to the invention have excellent cleaning and rinsing results and disintegration properties with an improved hardness.

### CROSS REFERENCE TO RELATED APPLICATIONS

The present application is a continuation of International Application No. PCT/EP2008/064807 filed 13 Oct. 2008, which claims priority to German Patent Application No. 10 2007 059 677.6 filed 10 Dec. 2007.

The present patent application is directed towards cleaning agents, particularly cleaning agents for automatic dishwashing. The present application in particular is directed towards citrate-containing automatic dishwashing agent tablets.

Today, more stringent requirements are often applied to machine washed dishes than to hand washed dishes. For example, after machine washing, dishes should not only be completely free of food residues but should also not exhibit any whitish blemishes due to water hardness or other mineral salts originating from dried water drops due to a lack of wetting agents.

Modern automatic dishwashing agents satisfy these requirements by incorporating washing, conditioning, water softening and rinsing active ingredients, commonly known as “2-in-1” or “3-in-1” dishwashing agents. Automatic dishwashing agents intended for private consumers contain builders as an essential component for successful washing and rinsing. These builders increase the alkalinity of the washing liquor, fats and oils being emulsified and saponified as alkalinity rises, while reducing the water hardness of the washing liquor by complexing the calcium ions present in the aqueous liquor. Alkali metal phosphates have proved to be particularly effective builders, and therefore typically constitute the main ingredient of the majority of commercially available automatic dishwashing agents.

While phosphates are very highly regarded in terms of their advantageous action as a component of automatic dishwashing agents, their use is, however, not entirely unproblematic from an environmental protection standpoint since a significant proportion of the phosphate passes with domestic wastewater into bodies of water and, especially in standing bodies of water (lakes, dams), plays a considerable part in their eutrophication or overfertilization. As a consequence of this phenomenon, use of pentasodium triphosphate in textile washing agents has been considerably reduced by statutory regulations in a number of countries such as the United States, Canada, Italy, Sweden and Norway, and has been entirely prohibited in Switzerland. Since 1984 in Germany, the maximum content of this builder permitted in washing agents has been 20%.

Phosphate replacements or substitutes in textile washing agents include nitrilotriacetic acid as well as sodium aluminum silicates (zeolites). However, for various reasons these substances are not suitable for use in automatic dishwashing agents. A series of replacements have accordingly been discussed in the literature as alternatives to alkali metal phosphates in automatic dishwashing agents, among which citrates are of particular significance.

European patents EP 662 117 B1 (Henkel KGaA) and EP 692 020 B1 (Henkel KGaA), for example, describe phosphate-free automatic dishwashing agents which, in addition to a citrate, furthermore contain carbonates, bleaching agents and enzymes.

Despite efforts to date, manufacturers of automatic dishwashing agents have not been able to provide phosphate-free automatic dishwashing agents which surpass or are even comparable to phosphate-containing cleaning agents with respect to washing and rinsing performance, in particular, their performance in terms of film deposition inhibition. Such equality of performance is, however, a prerequisite for successful market introduction of phosphate-free cleaning agents, since the majority of end consumers, despite the widespread public discussion of environmental issues, typically will decide against an environmentally advantageous product if this product is not in line with the market standard in terms of price and/or performance.

Against this background, the present application seeks to provide a phosphate-reduced or phosphate-free automatic dishwashing agent which comparable to or even surpasses conventional phosphate-containing cleaning agents both in cleaning performance and in rinsing results, as well as its performance in film deposition inhibition, preferably in tablet form for the consumer.

It has now been found that by combining hydrophobically modified anionic polymers with a mixture of citrate and citric acid, automatic dishwashing agent tablets can be provided having very good cleaning and rinsing results, while also exhibiting improved hardness and disintegration characteristics.

Therefore, in one embodiment, the present application provides a mono- or multiphase automatic dishwashing agent tablet made from press-molded particulate material, wherein at least one tablet phase A, based on total weight of the phase A, comprises—

a) 5 to 50 wt. % of citrate,

b) 1 to 20 wt. % of citric acid,

c) 0.1 to 40 wt. % of anionic polymer(s), comprising
i) monomers containing acid groups
ii) further nonionic monomers.

A basis of the advantageous washing and rinsing performance of automatic dishwashing agents according to the invention is their content of citrate a), citric acid b) and anionic polymer c).

A basis of the advantageous hardness and disintegration characteristics of tablet phases A according to the invention is the combination of citrate a), citric acid b) and anionic polymer c). In other words, hardness and disintegration characteristics of a tablet phase containing two of the three above-stated components a), b) and c) is surprisingly improved by addition of the third component.

For example, considering a tablet phase containing citrate and citric acid, the hardness and disintegration characteristic of this tablet phase is improved by addition of the anionic copolymer c). The improvement in phase hardness and phase disintegration is observed when anionic copolymers containing nonionic monomers are added, but not when anionic copolymers containing no nonionic monomers are added.

Dishwashing agent tablets according to the invention may comprise one or more phases. Preferably, automatic dishwashing agent tablets according to the invention include tablets having two or more phases.

Dishwashing agent tablets according to the invention are produced by press-molding particulate premixes. For the purposes of the present application, a “tablet phase” therefore refers to a body produced by tableting a particulate premix and not, for example, to a granular product contained in the particular premix. These phases may for example take the form of layers, inserts (for example cores in a recessed tablet) or inclusions. A dishwashing agent tablet according to the invention preferably comprises at least one layer, preferably two, three or more layers. At least one of these layers corresponds in composition to the above-stated tablet phase A.

A first distinguishing component of agents according to the invention is citrate. The term “citrate” includes salts of citric acid, in particular the alkali metal salts thereof. Particularly preferred automatic dishwashing agents according to the invention contain citrate, preferably sodium citrate, in amounts of 10 to 45 wt. %, preferably 15 to 40 wt. %, each based on total weight of the dishwashing agent tablet phase.

A second distinguishing ingredient of agents according to the invention is citric acid. The term “citric acid” includes citric acid itself but not the salts thereof. Particularly preferred automatic dishwashing agents according to the invention contain citric acid in amounts of 2 to 15 wt. %, preferably 5 to 12 wt. %, each based on total weight of the dishwashing agent tablet phase.

Concerning tablet hardness and tablet disintegration, particularly advantageous automatic dishwashing agents have a weight ratio of citrate to citric acid amounts in at least one of the tablet phases of 40:1 to 2:1, preferably 30:1 to 2:1 and in particular 20:1 to 2:1.

Automatic dishwashing agents according to the invention contain as a third component anionic polymer(s), including monomer(s) containing acid groups and nonionic monomer(s). The proportion by weight of this copolymer relative to total weight of the tablet phase is preferably from 0.2 to 20 wt. %, more preferably from 0.5 to 15 wt. % and in particular from 1.0 to 10 wt. %.

The following table shows some example formulations of such preferred tablet phases A:

| | Formulation | Formulation | Formulation | |
|---|---|---|---|---|
| | 1 | 2 | 3 | Formulation 4 |
| Ingredient | [wt. %] | [wt. %] | [wt. %] | [wt. %] |
| Citrate | 5 to 50 | 10 to 45 | 15 to 40 | 15 to 40 |
| Citric acid | 2 to 15 | 2 to 15 | 2 to 15 | 5 to 12 |
| Copolymer¹ | 0.1 to 40 | 0.2 to 20 | 0.5 to 15 | 1.0 to 10 |
| Misc. | Ad 100 | Ad 100 | Ad 100 | Ad 100 |

¹Copolymer(s) comprising i) monomers containing acid groups ii) further nonionic monomers

In those copolymers solely containing monomers from groups i) and ii), monomeric distribution of the copolymers used according to the invention preferably is from 5 to 95 wt. % of i) or ii), particularly preferably 50 to 90 wt. % of monomer(s) from group i) and 10 to 50 wt. % of monomer(s) from group ii), each based on total weight of the copolymer.

Copolymers c) can vary with regard to the chemical nature of their monomers. For example, the copolymer can also contain ionic or nonionic monomers in addition to monomers i) and ii).

In one preferred embodiment, copolymers c) have at least one unsaturated carboxylic acid as the monomer containing acid groups. Preferred unsaturated carboxylic acids i) in these special copolymers c) include unsaturated carboxylic acids of the formula R¹(R²)C═C(R³)COOH, wherein R¹ to R³ mutually independently are —H, —CH₃, a straight-chain or branched saturated alkyl residue with 2 to 12 carbon atoms, a straight-chain or branched, mono- or polyunsaturated alkenyl residue with 2 to 12 carbon atoms, alkyl or alkenyl residues substituted with —NH₂, —OH or —COON as defined above or are —COON or —COOR⁴, R⁴ being a saturated or unsaturated, straight-chain or branched hydrocarbon residue having 1 to 12 carbon atoms.

Particularly preferred unsaturated carboxylic acids include acrylic acid, methacrylic acid, ethacrylic acid, α-chloroacrylic acid, α-cyanoacrylic acid, crotonic acid, α-phenylacrylic acid, maleic acid, maleic anhydride, fumaric acid, itaconic acid, citraconic acid, methylenemalonic acid, sorbic acid, cinnamic acid or mixtures thereof.

Preferred dishwashing agent tablets according to the invention include an anionic polymer c) which is a homo- or copolymer of a carboxylic acid, preferably of acrylic acid or methacrylic acid or maleic acid.

Carboxylic acid groups can be present in the polymers in partially or entirely neutralized form (i.e., the acidic hydrogen atom of the carboxylic acid group may be replaced in some or all of the carboxylic acid groups with metal ions, preferably alkali metal ions and in particular with sodium ions). It is preferred according to the invention to use partially or completely neutralized copolymers containing carboxylic acid groups.

Molar mass of copolymers containing carboxylic acid groups preferably used according to the invention can be varied in order to tailor the properties of the polymers for the intended application. Molar masses of the copolymers preferably are from 2000 to 200,000 gmol⁻¹, more preferably from 4000 to 25,000 gmol⁻¹ and in particular from 5000 to 15,000 gmol⁻¹.

The following table shows some example formulations of such preferred tablet phases A:

| | Formulation | Formulation | Formulation | |
|---|---|---|---|---|
| | 5 | 6 | 7 | Formulation 8 |
| Ingredient | [wt. %] | [wt. %] | [wt. %] | [wt. %] |
| Citrate | 5 to 50 | 10 to 45 | 15 to 40 | 15 to 40 |
| Citric acid | 2 to 15 | 2 to 15 | 2 to 15 | 5 to 12 |
| Copolymer¹ | 0.1 to 40 | 0.2 to 20 | 0.5 to 15 | 1.0 to 10 |
| Misc. | Ad 100 | Ad 100 | Ad 100 | Ad 100 |

¹Copolymer(s) comprising i) monomers containing carboxylic acid groups ii) further nonionic monomers.

In another preferred embodiment, copolymers c) have at least one unsaturated sulfonic acid as the monomer containing acid groups. These preferentially used copolymers containing sulfonic acid groups contain as monomer i) monomers preferably containing sulfonic acid groups of the formula R⁵(R⁶)C═C(R⁷)—X—SO₃H, wherein R⁵ to R⁷ are mutually and independently —H, —CH₃, a straight-chain or branched saturated alkyl residue with 2 to 12 carbon atoms, a straight-chain or branched, mono- or polyunsaturated alkenyl residue with 2 to 12 carbon atoms, alkyl or alkenyl residues substituted with —OH or —COOH, or are —COOH or —COOR⁴, R⁴ being a saturated or unsaturated, straight-chain or branched hydrocarbon residue with 1 to 12 carbon atoms, and X an optionally present spacer group chosen from —(CH₂)ₙ— with n=0 to 4, —COO—(CH₂)ₖ— with k=1 to 6, —C(O)—NH—C(CH₃)₂— and —C(O)—NH—CH(CH₂CH₃)—.

Preferred among these monomers are those of the formulae—

H₂C═CH—X—SO₃H

H₂C═C(CH₃)—X—SO₃H

HO₃S—X—(R⁶)C═C(R⁷)—X—SO₃H

wherein R⁶ and R⁷ are each independently —H, —CH₃, —CH₂CH₃, —CH₂CH₂CH₃, —CH(CH₃)₂; and X is an optionally present spacer group chosen from —(CH₂)ₖ— with n=0 to 4, —COO—(CH₂)ₖ— with k=1 to 6, —C(O)—NH—C(CH₃)₂— and —C(O)—NH—CH(CH₂CH₃)—.

Particularly preferred monomers containing sulfonic acid groups include 1-acrylamido-1-propanesulfonic acid, 2-acrylamido-2-propanesulfonic acid, 2-acrylamido-2-methyl-1-propanesulfonic acid, 2-methacrylamido-2-methyl-1-propanesulfonic acid, 3-methacrylamido-2-hydroxypropanesulfonic acid, allylsulfonic acid, methallylsulfonic acid, allyloxybenzenesulfonic acid, methallyloxybenzenesulfonic acid, 2-hydroxy-3-(2-propenyloxy)propanesulfonic acid, 2-methyl-2-propene-1-sulfonic acid, styrenesulfonic acid, vinylsulfonic acid, 3-sulfopropyl acrylate, 3-sulfopropyl methacrylate, sulfomethacrylamide, sulfomethylmethacrylamide and mixtures of the stated acids or the water-soluble salts thereof.

Sulfonic acid groups can be present in the polymers in partially or entirely neutralized form (i.e., the acidic hydrogen atom of the sulfonic acid group can be replaced in some or all of the sulfonic acid groups with metal ions, preferably alkali metal ions and in particular with sodium ions). Preferably, copolymers containing partially or completely neutralized sulfonic acid groups are used.

Molar mass of the sulfo-copolymers preferably used according to the invention can be varied in order to tailor the properties of the polymers for the intended application. Preferred automatic dishwashing agents have copolymers having molar masses from 2000 to 200,000 gmol⁻¹, preferably 4000 to 25,000 gmol⁻¹ and in particular 5000 to 15,000 gmol⁻¹.

The following table shows some example formulations of such preferred tablet phases A:

| | Formulation | Formulation | Formulation | Formulation 12 |
|---|---|---|---|---|
| Ingredient | 9 [wt. %] | 10 [wt. %] | 11 [wt. %] | [wt. %] |
| Citrate | 5 to 50 | 10 to 45 | 15 to 40 | 15 to 40 |
| Citric acid | 2 to 15 | 2 to 15 | 2 to 15 | 5 to 12 |
| Copolymer¹ | 0.1 to 40 | 0.2 to 20 | 0.5 to 15 | 1.0 to 10 |
| Misc. | Ad 100 | Ad 100 | Ad 100 | Ad 100 |

¹Copolymer(s) comprising i) monomers containing sulfonic acid groups ii) further nonionic monomers

Preferred copolymers c) preferably contain as nonionic monomers ii) monomers from mono- or polyunsaturated hydrocarbon residues with 2 to 26 carbon atoms.

A first group of preferred automatic dishwashing agents therefore includes copolymer(s) c), which comprise(s)—
i) monomers from the group of monomers containing acid groups;
ii) monomers from the group of mono- or polyunsaturated hydrocarbon residues with 2 to 26 carbon atoms.

The following table shows some example formulations of such preferred tablet phases A:

| | Formulation | Formulation | Formulation | Formulation 16 |
|---|---|---|---|---|
| Ingredient | 13 [wt. %] | 14 [wt. %] | 15 [wt. %] | [wt. %] |
| Citrate | 5 to 50 | 10 to 45 | 15 to 40 | 15 to 40 |
| Citric acid | 2 to 15 | 2 to 15 | 2 to 15 | 5 to 12 |
| Copolymer¹ | 0.1 to 40 | 0.2 to 20 | 0.5 to 15 | 1.0 to 10 |
| Misc. | Ad 100 | Ad 100 | Ad 100 | Ad 100 |

¹Copolymer(s) comprising i) monomers from the group of monomers containing acid groups ii) monomers from the group of mono- or polyunsaturated hydrocarbon residues with 2 to 26 carbon atoms

Unsaturated hydrocarbon residues ii) used in the copolymers c), for example, in the above-described preferred copolymers c) having a monomer i) containing carboxylic acid or sulfonic acid groups, preferably are monomers according to general formula R¹(R²)C═C(R³)—X—R⁴, wherein R¹ to R³ are mutually and independently —H, —CH₃ or —C₂H₅, X is an optionally present spacer group chosen from —CH₂—, —C(O)O— and —C(O)—NH—, and R⁴ is a straight-chain or branched saturated alkyl residue with 2 to 22 carbon atoms or is an unsaturated, preferably aromatic residue with 6 to 22 carbon atoms.

Particularly preferred unsaturated hydrocarbon residues include butene, isobutene, pentene, 3-methylbutene, 2-methylbutene, cyclopentene, hexene, 1-hexene, 2-methyl-1-pentene, 3-methyl-1-pentene, cyclohexene, methylcyclopentene, cycloheptene, methylcyclohexene, 2,4,4-trimethyl-1-pentene, 2,4,4-trimethyl-2-pentene, 2,3-dimethyl-1-hexene, 2,4-dimethyl-1-hexene, 2,5-dimethyl-1-hexene, 3,5-dimethyl-1-hexene, 4,4-dimethyl-1-hexane, ethylcyclohexyne, 1-octene, α-olefins with 10 or more carbon atoms such as for example 1-decene, 1-dodecene, 1-hexadecene, 1-octadecene and C₂₂-α-olefin, 2-styrene, α-methylstyrene, 3-methylstyrene, 4-propylstyrene, 4-cyclohexylstyrene, 4-dodecylstyrene, 2-ethyl-4-benzylstyrene, 1-vinylnaphthalene, 2-vinylnaphthalene, methyl acrylate, ethyl acrylate, propyl acrylate, butyl acrylate, pentyl acrylate, hexyl acrylate, methyl methacrylate, N-(methyl)acrylamide, 2-ethylhexyl acrylate, 2-ethylhexyl methacrylate, N-(2-ethylhexyl)acrylamide, octyl acrylate, octyl methacrylate, N-(octyl)acrylamide, lauryl acrylate, lauryl methacrylate, N-(lauryl)acrylamide, stearyl acrylate, stearyl methacrylate, N-(stearyl)acrylamide, behenyl acrylate, behenyl methacrylate and N-(behenyl)acrylamide or mixtures thereof.

As an alternative to the above-stated embodiments the anionic polymers c) used in the tablet phases A according to the invention may also contain a combination of carboxylic monomers containing carboxylic acid groups and monomers containing sulfonic acid groups.

Dishwashing agent tablets according to any one of the above embodiments, wherein the anionic polymer c) is a copolymer of—

i) monomer containing carboxylic acid groups

ii) monomer containing sulfonic acid groups

iii) nonionogenic monomer,

are preferred according to the invention.

In addition to the above-stated ingredients, dishwashing agent tablets according to the invention can further include substances with a washing or cleaning action, preferably from builders, surfactants, polymers, bleaching agents, bleach activators, enzymes, glass corrosion inhibitors, corrosion inhibitors, disintegration auxiliaries, scents and perfume carriers. These preferred ingredients are described in greater detail below.

Builders in particular include silicates, carbonates and organic cobuilders, as well as phosphates.

Automatic dishwashing agents according to the invention preferably contain as builders crystalline layered silicates of the general formula NaMSiₓO₂ₓ₊₁.yH₂O, wherein M is sodium or hydrogen, x is a number from 1.9 to 22, preferably from 1.9 to 4, particularly preferred values for x being 2, 3 or 4, and y is a number from 0 to 33, preferably from 0 to 20.

Amorphous sodium silicates having an Na₂O:SiO₂ modulus of 1:2 to 1:3.3, preferably 1:2 to 1:2.8 and in particular 1:2 to 1:2.6 can also be used, which are preferably dissolution-retarded and exhibit secondary washing characteristics.

Preferred automatic dishwashing agents include 2 to 15 wt. % preferably 3 to 12 wt. % and in particular 4 to 8 wt. % of silicate(s).

It is particularly preferred to use carbonate(s) and/or hydrogencarbonate(s), preferably alkali metal carbonate(s), particularly preferably sodium carbonate, in quantities of 1 to 60 wt. %, preferably 5 to 55 wt. % and in particular 10 to 50 wt. %, based on total weight of the automatic dishwashing agent.

Dishwashing agent tablets containing, based on total weight of the tablet, from 1 to 60 wt. %, preferably from 5 to 55, and in particular from 10 to 50 wt. % of carbonate, are preferred according to the invention.

The following table shows some example formulations of preferred carbonate-containing tablet phases A:

| | Formulation | Formulation | Formulation | Formulation 20 |
|---|---|---|---|---|
| Ingredient | 17 [wt. %] | 18 [wt. %] | 19 [wt. %] | [wt. %] |
| Citrate | 5 to 50 | 10 to 45 | 15 to 40 | 15 to 40 |
| Citric acid | 2 to 15 | 2 to 15 | 2 to 15 | 5 to 12 |
| Copolymer¹ | 0.1 to 40 | 0.2 to 20 | 0.5 to 15 | 1.0 to 10 |
| Sodium | 1 to 60 | 5 to 55 | 10 to 50 | 10 to 50 |
| carbonate/ | | | | |
| sodium | | | | |
| hydrogen- | | | | |
| carbonate | | | | |
| Misc. | Ad 100 | Ad 100 | Ad 100 | Ad 100 |

¹Copolymer(s) comprising i) monomers containing acid groups ii) further nonionic monomers

Organic cobuilders which may in particular be mentioned include polycarboxylates/polycarboxylic acids, polymeric carboxylates, aspartic acid, polyacetals, dextrins and further organic cobuilders. These classes of substances are described below.

Usable organic builder materials include polycarboxylic acids in the form of the free acid and/or the sodium salts thereof, polycarboxylic acids being those carboxylic acids having more than one acid function. In addition to the above-mentioned citric acid, these include adipic acid, succinic acid, glutaric acid, malic acid, tartaric acid, maleic acid, fumaric acid, saccharic acids, aminocarboxylic acids, nitrilotriacetic acid (NTA) and mixtures of these, provided that there are no environmental objections against such use. Apart from their builder action, free acids typically also have an acidifying component and so also serve to establish a lower and gentler pH value for washing or cleaning agents. Citric acid, succinic acid, glutaric acid, adipic acid, gluconic acid and any desired mixtures of these may in particular be mentioned.

Among the numerous commercially obtainable phosphates, alkali metal phosphates have the greatest significance in the washing and cleaning agent industry, with pentasodium or pentapotassium triphosphate (sodium or potassium tripolyphosphate) being particularly preferred.

“Alkali metal phosphates” refers to alkali metal (in particular sodium and potassium) salts of the various phosphoric acids, it being possible to distinguish between meta-phosphoric acids (HPO₃)ₙ and ortho-phosphoric acid H₃PO₄ as well as higher molecular weight representatives. These phosphates have a number of advantages: they act as alkalinity donors, prevent lime deposits on machine parts or lime incrustation of fabrics and, moreover, contribute to cleaning performance.

Phosphates which are of particular industrial importance include pentasodium triphosphate, Na₅P₃O₁₀ (sodium tripolyphosphate) and the corresponding potassium salt pentapotassium triphosphate, K₅P₃O₁₀ (potassium tripolyphosphate). Sodium potassium tripolyphosphates are also preferably used according to the invention.

If, for the purposes of the present application, phosphates are used as substances with a washing or cleaning action in automatic dishwashing agent tablets, preferred tablets contain this/these phosphate(s), preferably alkali metal phosphate(s), particularly preferably pentasodium or pentapotassium triphosphate (sodium or potassium tripolyphosphate), in quantities of less than 20 wt. %, preferably less than 10 wt. % and in particular less than 5 wt. %. Particularly preferred automatic dishwashing agent tablets according to the invention contain no inorganic phosphates.

The following table provides example formulations of preferred tablet phases A as a component of phosphate-free automatic dishwashing agent tablets:

| | Formulation | Formulation | Formulation | Formulation 24 |
|---|---|---|---|---|
| Ingredient | 21 [wt. %] | 22 [wt. %] | 23 [wt. %] | [wt. %] |
| Citrate | 5 to 50 | 10 to 45 | 15 to 40 | 15 to 40 |
| Citric acid | 2 to 15 | 2 to 15 | 2 to 15 | 5 to 12 |
| Copolymer¹ | 0.1 to 40 | 0.2 to 20 | 0.5 to 15 | 1.0 to 10 |
| Misc. | Ad 100 | Ad 100 | Ad 100 | Ad 100 |

¹Copolymer(s) comprising i) monomers containing acid groups ii) further nonionic monomers

In addition to the active ingredient combination of citrate, citric acid and anionic polymer, complexing agents, preferably phosphonates, are used in preferred dishwashing agent tablets. Particularly preferred dishwashing agent tablets according to the invention include tablets having at least one complexing agent, preferably 1-hydroxyethane-1,1-diphosphonic acid and/or methylglycinediacetic acid.

In addition to 1-hydroxyethane-1,1-diphosphonic acid, complexing phosphonates include a series of different compounds such as diethylenetriaminepenta(methylenephosphonic acid) (DTPMP). Hydroxyalkane- or aminoalkanephosphonates in particular are preferred in the present application. Among hydroxyalkanephosphonates, 1-hydroxyethane-1,1-diphosphonate (HEDP) is of particular significance as a cobuilder. It is preferably used as a sodium salt, the disodium salt exhibiting a neutral reaction and the tetrasodium salt an alkaline (pH 9) reaction. Preferred aminoalkanephosphonates include ethylenediaminetetramethylenephosphonate (EDTMP), diethylenetriaminepentamethylenephosphonate (DTPMP) as well as the higher homologs thereof. They are preferably used in the form of the sodium salts which exhibit a neutral reaction, for example, as the hexasodium salt of EDTMP or as the hepta- and octasodium salt of DTPMP. From the class of phosphonates, HEDP is here preferably used as a builder. Aminoalkanephosphonates furthermore exhibit a pronounced heavy metal binding capacity. It may accordingly be preferred, especially if the agents also contain bleach, to use aminoalkanephosphonates, in particular DTPMP, or mixtures of the stated phosphonates.

A preferred automatic dishwashing agent contains one or more phosphonate(s) from the group—
a) aminotrimethylenephosphonic acid (ATMP) and/or the salts thereof;
b) ethylenediaminetetra(methylenephosphonic acid) (EDTMP) and/or the salts thereof;
c) diethylenetriaminepenta(methylenephosphonic acid) (DTPMP) and/or the salts thereof;
d) 1-hydroxyethane-1,1-diphosphonic acid (HEDP) and/or the salts thereof;
e) 2-phosphonobutane-1,2,4-tricarboxylic acid (PBTC) and/or the salts thereof;
f) hexamethylenediaminetetra(methylenephosphonic acid) (HDTMP) and/or the salts thereof;
g) nitrilotri(methylenephosphonic acid) (NTMP) and/or the salts thereof.

Particularly preferred automatic dishwashing agents include 1-hydroxyethane-1,1-diphosphonic acid (HEDP) or diethylenetriaminepenta(methylenephosphonic acid) (DTPMP) as phosphonates.

Automatic dishwashing agents according to the invention may, of course, contain two or more different phosphonates.

In a preferred embodiment, the proportion by weight of the phosphonate(s) in the total weight of the automatic dishwashing agent is less than the proportion by weight of the polymer(s) b). In other words, particularly preferred agents are those in which the ratio of the proportion by weight of polymer b) to the proportion by weight of phosphonate amounts to 200:1 to 2:1, preferably 150:1 to 2:1, particularly preferably 100:1 to 2:1, very particularly preferably 80:1 to 3:1 and in particular 50:1 to 5:1.

The proportion by weight of these complexing agents, in particular the total of the proportions by weight of 1-hydroxyethane-1,1-diphosphonic acid (HEDP) and methylglycinediacetic acid (MGDA), preferably amounts to 0.5 to 14 wt. %, preferably 1 to 12 wt. % and in particular 2 to 8 wt. %.

Preferred automatic dishwashing agent tablets contain enzyme(s) to enhance washing or cleaning performance. These include in particular proteases, amylases, lipases, hemicellulases, cellulases, perhydrolases or oxidoreductases, and preferably mixtures thereof. These enzymes are in principle of natural origin. Starting from natural molecules, improved variants are available for use in washing or cleaning agents, these variants preferably being used. Washing or cleaning agents preferably contain enzymes in total quantities of 1×10⁻⁶ to 5 wt. % relative to active protein. Protein concentration may be determined using known methods such as the BCA method or the biuret method.

Among proteases, those of the subtilisin type are preferred. Examples of these are subtilisins BPN′ and Carlsberg and their further developed forms protease PB92, subtilisins 147 and 309, alkaline protease from Bacillus lentus, subtilisin DY and the enzymes thermitase, proteinase K and proteases TW3 and TW7, which are classed among subtilases but no longer among the subtilisins as more narrowly defined.

Examples of amylases usable according to the invention are the α-amylases from Bacillus licheniformis, from B. amyloliquefaciens, from B. stearothermophilus, from Aspergillus niger and A. oryzae and the further developed forms of the above-stated amylases which have been improved for use in washing and cleaning agents. Particular note should furthermore be taken for this purpose of the α-amylase from Bacillus sp. A 7-7 (DSM 12368) and the cyclodextrin glucanotransferase (CGTase) from B. agaradherens (DSM 9948).

Lipases or cutinases, particularly due to their triglyceride-cleaving activities but also in order to produce peracids in situ from suitable precursors, may furthermore be used according to the invention. These include lipases originally obtainable or further developed from Humicola lanuginosa (Thermomyces lanuginosus), in particular those with the D96L amino acid substitution. Furthermore, cutinases originally isolated from Fusarium solani pisi and Humicola insolens are also usable. Lipases or cutinases, the initial enzymes of which were originally isolated from Pseudomonas mendocina and Fusarium solanii, may furthermore be used.

Enzymes which fall within the class of hemicellulases may furthermore be used. These include mannanases, xanthan lyases, pectin lyases (=pectinases), pectin esterases, pectate lyases, xyloglucanases (=xylanases), pullulanases and β-glucanases.

Oxidoreductases, for example oxidases, oxygenases, catalases, peroxidases, such as halo-, chloro-, bromo-, lignin, glucose or manganese peroxidases, dioxygenases or laccases (phenol oxidases, polyphenol oxidases) can be used according to the invention to increase bleaching action. Compounds, preferably organic compounds, particularly preferably aromatic compounds, which interact with the enzymes are also advantageously added to enhance activity of the oxidoreductases in question (enhancers) or, in the event of a major difference in redox potential between the oxidizing enzymes and the soiling, to ensure electron flow (mediators).

Enzymes with a washing or cleaning action such as proteases and amylases are not generally provided in pure protein form but rather in the form of stabilized storable and transportable preparations. These preformulated preparations include, for example, solid preparations obtained by granulation, extrusion or freeze-drying or, in particular in the case of preparations in liquid or gel form, solutions of the enzymes, advantageously as concentrated as possible, with a low water content and/or combined with stabilizers or further auxiliaries.

Alternatively, for both the solid and liquid presentation, the enzymes can be encapsulated, for example, by spray drying or extruding the enzyme solution together with a preferably natural polymer, or in the form of capsules, for example, those in which the enzymes are enclosed in a solidified gel or those of the core-shell type, in which an enzyme-containing core is coated with a protective layer which is impermeable to water, air and/or chemicals. Further active ingredients such as stabilizers, emulsifiers, pigments, bleaching agents or dyes may additionally be applied in superimposed layers. Such capsules are applied in accordance with per se known methods, for example, by agitated or rolling granulation or in fluidized bed processes. Preferably, such granules are low-dusting due to, for example, application of polymeric film formers, and are storage stable due to the coating.

It is furthermore possible to formulate two or more enzymes together so that a single granular product comprises two or more enzyme activities.

As is clear from the preceding explanations, enzyme proteins constitute only a fraction of the total weight of conventional enzyme preparations. Enzyme preparations preferably used according to the invention, such as protease and amylase preparations, contain from 0.1 to 40 wt. %, preferably from 0.2 to 30 wt. %, particularly preferably from 0.4 to 20 wt. % and in particular from 0.8 to 10 wt. % of the enzyme protein.

Preferred dishwashing agent tablets contain, based on total weight of the tablet, 0.2 to 5 wt. %, preferably 0.5 to 5 wt. % and in particular 0.1 to 4 wt. % of one or more enzyme preparation(s).

Preferred automatic dishwashing agents according to the invention furthermore contain one or more bleaching agents. Among those compounds acting as bleaching agents which release H₂O₂ in water, sodium percarbonate, sodium perborate tetrahydrate and sodium perborate monohydrate are of particular significance. Further usable bleaching agents include peroxypyrophosphates, citrate perhydrates and H₂O₂-releasing per-acidic salts or per-acids such as perbenzoates, peroxophthalates, diperazelaic acid, phthaloimino per-acid or diperdodecanedioic acid.

Organic bleaching agents may also be used. Typical organic bleaching agents include diacyl peroxides such as dibenzoyl peroxide. Further typical organic bleaching agents include peroxy acids, including alkylperoxy acids and arylperoxy acids. Preferred dishwashing agent tablets according to the invention contain, based on total weight of the tablet, 1 to 20 wt. %, preferably 2 to 15 wt. % and in particular 4 to 12 wt. % of sodium percarbonate.

In order to achieve enhanced bleaching action when washing at temperatures of 60° C. and below, automatic dishwashing agent tablets according to the invention may also contain bleach activators. Useful bleach activators include compounds which, under perhydrolysis conditions, yield aliphatic peroxycarboxylic acids with preferably 1 to 10 C atoms, in particular 2 to 4 C atoms, and/or optionally substituted perbenzoic acid. Suitable substances are those which bear O- and/or N-acyl groups having the stated number of C atoms and/or optionally substituted benzoyl groups. Polyacylated alkylenediamines are preferred, tetraacetylethylenediamine (TAED) having proved particularly suitable.

Bleach activators, particularly TAED, are preferably used in quantities of up to about 10 wt. %, particularly 0.1 wt. % to 8 wt. %, more particularly 2 to 8 wt. % and particularly preferably 2 to 6 wt. %, based on total weight of the agents containing bleach activator.

“Bleach catalysts” may also be used in addition to or instead of conventional bleach activators. These substances contain bleach-boosting transition metal salts or transition metal complexes such as Mn, Fe, Co, Ru or Mo salen complexes or carbonyl complexes. Mn, Fe, Co, Ru, Mo, Ti, V and Cu complexes with nitrogenous tripod ligands and Co, Fe, Cu and Ru ammine complexes may also be used as bleach catalysts.

Complexes of manganese in oxidation state II, III, IV or IV preferably containing one or more macrocyclic ligand(s) with N, NR, PR, O and/or S donor functions are particularly preferentially used. Ligands having nitrogen donor functions are preferably used. It is particularly preferred to use bleach catalyst(s) in agents according to the invention containing as macromolecular ligand 1,4,7-trimethyl-1,4,7-triazacyclononane (Me-TACN), 1,4,7-triazacyclononane (TACN), 1,5,9-trimethyl-1,5,9-triazacyclododecane (Me-TACD), 2-methyl-1,4,7-trimethyl-1,4,7-triazacyclononane (Me/Me-TACN) and/or 2-methyl-1,4,7-triazacyclononane (Me/TACN). Suitable manganese complexes include [Mn^{III}₂(μ-O)₁(μ-OAc)₂(TACN)₂](ClO₄)₂, [Mn^{III}Mn^{Iv}(μ-O)₂(μ-OAc)₁(TACN)₂]-(BPh₄)₂, [Mn^{IV}₄(μ-O)₆(TACN)₄](ClO₄)₄, [Mn^{III}₂(μ-O)₁(μ-OAc)₂(Me-TACN)₂]-(ClO₄)₂, [Mn^{III}Mn^{IV}(μ-O)₁(μ-OAc)₂(Me-TACN)₂](ClO₄)₃, [Mn^{IV}₂(μ-O)₃(Me-TACN)₂](PF₆)₂ and [Mn^{IV}₂(μ-O)₃(Me/Me-TACN)₂](PF₆)₂ (OAc═OC(O)CH₃).

Automatic dishwashing agent tablets which further contain a bleach catalyst chosen from bleach-boosting transition metal salts and transition metal complexes, preferably from complexes of manganese with 1,4,7-trimethyl-1,4,7-triazacyclononane (Me₃-TACN) or 1,2,4,7-tetramethyl-1,4,7-triazacyclononane (Me₄-TACN), are preferred according to the invention since the above-stated bleach catalysts can bring about a significant improvement in the cleaning result.

The above-stated bleach-boosting transition metal complexes, in particular with Mn and Co central atoms, are used in conventional quantities, preferably in a quantity of up to about 5 wt. %. Dishwashing agent tablets containing, based on total weight of the tablet, 0.01 to 2 wt. %, preferably 0.02 to 1 wt. %, and particularly 0.05 to 0.8 wt. % of bleach catalyst, are preferred according to the invention.

Preferred dishwashing agents according to the invention can have surfactants as an additional component. The addition of surfactants has proven particularly advantageous with regard to cleaning performance and drying, wherein, from the group of preferentially used nonionic surfactants, anionic surfactants and amphoteric surfactants, nonionic surfactants provide the best results. Anionic and amphoteric surfactants are preferably used in combination with defoamers or foam inhibitors.

Any nonionic surfactants known to a person skilled in the art may be used. Suitable nonionic surfactants include alkyl glycosides of the general formula RO(G)ₓ, wherein R is a primary straight-chain or methyl-branched aliphatic residue, particularly methyl-branched in position 2, with 8 to 22, preferably 12 to 18 C atoms and G is a glycose unit with 5 or 6 C atoms, preferably glucose. The degree of oligomerization x, representing the distribution of monoglycosides and oligoglycosides, is a number from 1 to 10; x is preferably 1.2 to 1.4.

Amine oxide nonionic surfactants, for example, N-coconut alkyl-N,N-dimethylamine oxide and N-tallow alcohol-N,N-dihydroxyethylamine oxide, and fatty acid alkanolamide nonionic surfactants may also be suitable. The quantity of these nonionic surfactants preferably amounts to no more than that of the ethoxylated fatty alcohols, in particular, no more than half the quantity thereof.

Further classes of preferably used nonionic surfactants, which may be used either as sole nonionic surfactant or in combination with other nonionic surfactants, are alkoxylated, preferably ethoxylated or ethoxylated and propoxylated fatty acid alkyl esters, preferably with 1 to 4 carbon atoms in the alkyl chain.

Low-foaming nonionic surfactants can be used as preferred surfactants. Washing or cleaning agents, particularly cleaning agents for automatic dishwashing, preferably contain nonionic surfactants from the group of alkoxylated alcohols. Alkoxylated, advantageously ethoxylated, in particular primary alcohols with preferably 8 to 18 C atoms and on average 1 to 12 mol of ethylene oxide (EO) per mol of alcohol, in which the alcohol residue may be linear or preferably methyl-branched in position 2 or may contain linear and methyl-branched residues in the mixture, as are usually present in oxo alcohol residues, are preferably used as nonionic surfactants. In particular, however, alcohol ethoxylates with linear residues prepared from alcohols of natural origin with 12 to 18 C atoms, for example from coconut, palm, tallow fat or oleyl alcohol, and on average 2 to 8 mol of EO per mol of alcohol are preferred. Preferred ethoxylated alcohols include, for example, C₁₂₋₁₄ alcohols with 3 EO or 4 EO, C₉₋₁₁ alcohol with 7 EO, C₁₃₋₁₅ alcohols with 3 EO, 5 EO, 7 EO or 8 EO, C₁₂₋₁₈ alcohols with 3 EO, 5 EO or 7 EO and mixtures of these, such as mixtures of C₁₂₋₁₄ alcohol with 3 EO and C₁₂₋₁₈ alcohol with 5 EO. The stated degrees of ethoxylation are statistical averages which, for a specific product, may be an integer or a fractional number. Preferred alcohol ethoxylates have a narrow homolog distribution (narrow range ethoxylates, NRE). In addition to these nonionic surfactants, fatty alcohols with more than 12 EO may also be used. Examples of these are tallow fatty alcohol with 14 EO, 25 EO, 30 EO or 40 EO.

Ethoxylated nonionic surfactants obtained from C₆₋₂₀ monohydroxyalkanols or C₆₋₂₀ alkylphenols or C₁₆₋₂₀ fatty alcohols and having more than 12 mol, preferably more than 15 mol and in particular more than 20 mol of ethylene oxide per mol of alcohol are accordingly particularly preferably used. One particularly preferred nonionic surfactant is obtained from a straight-chain fatty alcohol having 16 to 20 carbon atoms (C₁₆₋₂₀ alcohol), preferably a C₁₋₈ alcohol, and at least 12 mol, preferably at least 15 mol and in particular at least 20 mol of ethylene oxide. Among these, “narrow range ethoxylates” are particularly preferred.

Combinations of one or more tallow fatty alcohols with 20 to 30 EO and silicone defoamers are particularly preferentially used.

In particular, nonionic surfactants having a melting point of above room temperature are preferred. Nonionic surfactant(s) with a melting point of 20° C. or greater, preferably 25° C. or greater, particularly preferably from 25 to 60° C. and in particular from 26.6 to 43.3° C., is/are particularly preferred.

Suitable nonionic surfactants having melting or softening points in the stated temperature range include low-foaming nonionic surfactants which may be solid or highly viscous at room temperature. If nonionic surfactants which are highly viscous at room temperature are used, it is preferred that they have a viscosity of 20 Pa·s or greater, preferably 35 Pa·s or greater, and in particular 40 Pa·s or greater. Depending on their intended application, nonionic surfactants having a waxy consistency at room temperature are also preferred.

Alkoxylated alcohols nonionic surfactants, particularly preferably mixed alkoxylated alcohols and in particular EO-AO-EO nonionic surfactants, are likewise particularly preferentially used.

The nonionic surfactant which is solid at room temperature preferably comprises propylene oxide units in its molecule. Such PO units preferably comprise 25 wt. % or less, particularly preferably 20 wt. % or less, and in particular 15 wt. % or less of the total molar mass of the nonionic surfactant. Particularly preferred nonionic surfactants include ethoxylated monohydroxyalkanols or alkylphenols further comprising polyoxyethylene/polyoxypropylene block copolymer units. The alcohol or alkylphenol moiety of such nonionic surfactant molecules here preferably comprise more than 30 wt. %, particularly preferably more than 50 wt. % and in particular more than 70 wt. % of the total molar mass of such nonionic surfactants. Preferred agents contain ethoxylated and propoxylated nonionic surfactants, wherein the propylene oxide units comprise in each molecule up to 25 wt. %, preferably up to 20 wt. % and in particular up to 15 wt. % of the entire molar mass of the nonionic surfactant.

Preferably used surfactants originate from the groups comprising alkoxylated nonionic surfactants, in particular ethoxylated primary alcohols and mixtures of these surfactants with structurally complex surfactants such as polyoxypropylene/polyoxyethylene/polyoxypropylene ((PO/EO/PO) surfactants). Such (PO/EO/PO) nonionic surfactants are furthermore distinguished by good foam control.

Further nonionic surfactants with a melting point above room temperature which are particularly preferably used contain 40 to 70% of a polyoxypropylene/polyoxyethylene/polyoxypropylene block polymer blend, which contains 75 wt. % of a reverse block copolymer of polyoxyethylene and polyoxypropylene with 17 mol of ethylene oxide and 44 mol of propylene oxide and 25 wt. % of a block copolymer of polyoxyethylene and polyoxypropylene, initiated with trimethylolpropane and containing 24 mol of ethylene oxide and 99 mol of propylene oxide per mol of trimethylolpropane.

Nonionic surfactants particularly preferred for the purposes of the present invention are low-foaming nonionic surfactants having alternating ethylene oxide and alkylene oxide units. Among these, surfactants with EO-AO-EO-AO blocks are in turn preferred, wherein in each case one to ten EO or AO groups are attached to one another before being followed by a block of the respective other groups. Preferred nonionic surfactants are those of the general formula—

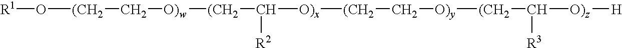

wherein R¹ is a straight-chain or branched, saturated or mono- or polyunsaturated C₆₋₂₄ alkyl or alkenyl residue; R² and R³ are each independently —CH₃, —CH₂CH₃, —CH₂CH₂—CH₃, or CH(CH₃)₂; and the indices w, x, y, z are each independently integers from 1 to 6.

Preferred nonionic surfactants of the above formula may be produced by known methods from the corresponding alcohols R¹—OH and ethylene or alkylene oxide. Residue R¹ in the above formula may vary depending on the origin of the alcohol. If natural sources are used, the residue R¹ is an even number of carbon atoms and is generally unbranched, preference being given to linear residues from alcohols of natural origin with 12 to 18 C atoms (e.g., from coconut, palm, tallow fat or oleyl alcohol). Alcohols obtainable from synthetic sources include Guerbet alcohols or residues methyl-branched in position 2 or linear and methyl-branched residues in a mixture as are conventionally present in oxo alcohol residues. Irrespective of the nature of the alcohol used for producing nonionic surfactants contained in the preparations, preferred nonionic surfactants are those wherein R¹ in the above formula is an alkyl residue with 6 to 24, preferably 8 to 20, particularly preferably 9 to 15 and in particular 9 to 11 carbon atoms.

Apart from propylene oxide, butylene oxide may in particular be considered as an alkylene oxide unit which alternates with the ethylene oxide unit in preferred nonionic surfactants. However, further alkylene oxides, wherein R² or R³ are mutually independently chosen from —CH₂CH₂—CH₃ or —CH(CH₃)₂ are also suitable. Nonionic surfactants of the above formula which are preferably used are those wherein R² or R³ is a residue —CH₃, w and x mutually independently are values of 3 or 4 and y and z mutually independently are values of 1 or 2.

In summary, preferred nonionic surfactants are particularly those having a C₉₋₁₅ alkyl residue with 1 to 4 ethylene oxide units, followed by 1 to 4 propylene oxide units, followed by 1 to 4 ethylene oxide units, followed by 1 to 4 propylene oxide units. In aqueous solution, these surfactants exhibit the necessary low viscosity and may particularly preferentially be used according to the invention.

Surfactants of the general formula R¹—CH(OH)CH₂O-(AO)_{w}-(A′O)ₓ-(A″O)_{y}-(A′″O)_{z}—R², wherein R¹ and R² are each mutually independently a straight-chain or branched, saturated or mono- or polyunsaturated C₂₋₄₀ alkyl or alkenyl residue; A, A′, A″ and A′″ are each mutually independently a residue from —CH₂CH₂, —CH₂CH₂—CH₂, —CH₂—CH(CH₃), —CH₂—CH₂—CH₂—CH₂, —CH₂—CH(CH₃)—CH₂—, —CH₂—CH(CH₂—CH₃); and w, x, y and z are values from 0.5 to 90, with x, y and/or z possibly also being 0, are preferred according to the invention.

In particular, preferred end group-terminated poly(oxyalkylated) nonionic surfactants include those which, according to the formula R¹O[CH₂CH₂O]ₓCH₂CH(OH)R², in addition to a residue R¹ which is a linear or branched, saturated or unsaturated, aliphatic or aromatic hydrocarbon residues with 2 to 30 carbon atoms, preferably with 4 to 22 carbon atoms, furthermore comprise a linear or branched, saturated or unsaturated, aliphatic or aromatic hydrocarbon residue R² with 1 to 30 carbon atoms, x being values from 1 to 90, preferably values from 30 to 80 and in particular values from 30 to 60.

Particularly preferred surfactants include those of the formula R¹O[CH₂CH(CH₃)O]ₓ[CH₂CH₂O]_{y}CH₂CH(OH)R², wherein R¹ is a linear or branched aliphatic hydrocarbon residue with 4 to 18 carbon atoms or mixtures thereof, R² is a linear or branched hydrocarbon residue with 2 to 26 carbon atoms or mixtures thereof, and x is a values from 0.5 to 1.5, and y is a value of at least 15.

Particularly preferred end group-terminated poly(oxyalkylated) nonionic surfactants further includes those of the formula R¹O[CH₂CH₂O]ₓ[CH₂CH(R³)O]_{y}CH₂CH(OH)R², wherein R¹ and R² mutually independently are a linear or branched, saturated or mono- or polyunsaturated hydrocarbon residue with 2 to 26 carbon atoms, R³ is mutually independently chosen from —CH₃, —CH₂CH₃, —CH₂CH₂—CH₃, —CH(CH₃)₂, but preferably is —CH₃, and x and y mutually independently are values from 1 to 32, with nonionic surfactants with R³═—CH₃ and values of x from 15 to 32 and y from 0.5 and 1.5 being very particularly preferred.

With use of the above-described nonionic surfactants having a free hydroxyl group on one of the two terminal alkyl residues, it is possible to achieve a distinct improvement in the formation of film deposits in automatic dishwashing versus conventional polyalkoxylated fatty alcohols without a free hydroxyl group.

Further preferably usable nonionic surfactants include end group-terminated poly(oxyalkylated) nonionic surfactants of the formula R¹O[CH₂CH(R³)O]ₓ[CH₂]ₖCH(OH)[CH₂]ⱼOR², wherein R¹ and R² are linear or branched, saturated or unsaturated, aliphatic or aromatic hydrocarbon residues with 1 to 30 carbon atoms, R³ is H or a methyl, ethyl, n-propyl, iso-propyl, n-butyl, 2-butyl or 2-methyl-2-butyl residue, x is a value from 1 to 30, k and j are values from 1 to 12, preferably from 1 to 5. If the value of x is ≧2, each R³ in the above formula R¹O[CH₂CH(R³)O]ₓ[CH₂]ₖCH(OH)[CH₂]ⱼOR² may be different. R¹ and R² are preferably linear or branched, saturated or unsaturated, aliphatic or aromatic hydrocarbon residues with 6 to 22 carbon atoms, residues with 8 to 18 C atoms being particularly preferred. H, —CH₃ or —CH₂CH₃ are particularly preferred for the residue R³. Particularly preferred values for x are in the range from 1 to 20, particularly 6 to 15.

As described above, each R³ in the above formula may be different if x is ≧2. In this manner, it is possible to vary the alkylene oxide unit in the square brackets. For example, if x is 3, the residue R³ may be selected in order to form ethylene oxide (R³═H) or propylene oxide (R³═CH₃) units which may be attached to one another in any sequence, for example (EO)(PO)(EO), (EO)(EO)(PO), (EO)(EO)(EO), (PO)(EO)(PO), (PO)(PO)(EO) and (PO)(PO)(PO). The value 3 for x has been selected here by way of example and may be larger, the range of variation increasing as the value of x rises and, for example, comprising a large number of (EO) groups combined with a small number of (PO) groups, or vice versa.

Particularly preferred end group-terminated poly(oxyalkylated) alcohols of the above-stated formula have values of k=1 and j=1, simplifying the above formula to R¹O[CH₂CH(R³)O]ₓCH₂CH(OH)CH₂OR². In this formula, R¹, R² and R³ are as defined above and x is a number from 1 to 30, preferably from 1 to 20, and particularly from 6 to 18. Particularly preferred surfactants are those in which R¹ and R² comprise 9 to 14 C atoms, R³ is H and x is a value from 6 to 15.

The stated C chain lengths and degrees of ethoxylation or degrees of alkoxylation of the above-stated nonionic surfactants are statistical averages which, for a specific product, may be an integer or a fractional number. Due to production methods, commercial products of the stated formulae do not in the main consist of an individual representative, but instead of mixtures, whereby not only the C-chain lengths but also the degrees of ethoxylation or degrees of alkoxylation may be averages and consequently fractional numbers.

The above-stated nonionic surfactants may, of course, be used not only as individual substances, but also as surfactant mixtures of two, three, four or more surfactants. Surfactant mixtures do not here comprise mixtures of nonionic surfactants all of which fall within one of the above-stated general formulae, but instead such mixtures which contain two, three, four or more nonionic surfactants which may be described by various of the above-stated general formulae.

In a preferred embodiment, the dishwashing agent tablet according to the invention, based on total weight of the tablet, contains nonionic surfactant in quantities of from 0.1 to 10 wt. %, preferably of 0.2 to 8 wt. % and in particular of from 3 to 6 wt. %.

Glass corrosion inhibitors prevent the occurrence of hazing, streaking and scratching, as well as iridescence on the surface of machine washed glasses. Preferred glass corrosion inhibitors originate from magnesium and zinc salts and magnesium and zinc complexes.

The spectrum of zinc salts preferred according to the invention, preferably of organic acids, particularly preferably of organic carboxylic acids, extends from salts which are sparingly soluble or insoluble in water (i.e., exhibit a solubility of below 100 mg/l, preferably of below 10 mg/l, in particular of below 0.01 mg/l) up to those salts which exhibit a solubility in water of above 100 mg/l, preferably of above 500 mg/l, particularly preferably of above 1 g/l and in particular of above 5 g/l (all solubilities at 20° C. water temperature). The first group of zinc salts includes for example zinc citrate, zinc oleate and zinc stearate, while the group of soluble zinc salts includes for example zinc formate, zinc acetate, zinc lactate and zinc gluconate.

At least one zinc salt of an organic carboxylic acid, particularly preferably a zinc salt from the group of zinc stearate, zinc oleate, zinc gluconate, zinc acetate, zinc lactate and zinc citrate is particularly preferentially used as a glass corrosion inhibitor. Zinc ricinoleate, zinc abietate and zinc oxalate are also preferred.

For the purposes of the present invention, the amount of zinc salt in washing or cleaning agents is preferably from 0.1 to 5 wt. %, preferably from 0.2 to 4 wt. % and particularly from 0.4 to 3 wt. %, or the amount of zinc in oxidized form (calculated as Zn²⁺) is from 0.01 to 1 wt. %, preferably from 0.02 to 0.5 wt. % and particularly from 0.04 to 0.2 wt. %, based on total weight of the preparation containing the glass corrosion inhibitor.

Corrosion inhibitors protect the items being washed or the machine, silver protection agents being of particular significance in relation to automatic dishwashing. Known prior art substances may be used. In general, useful silver protection agents include those primarily chosen from triazoles, benzotriazoles, bisbenzotriazoles, aminotriazoles, alkylaminotriazoles and transition metal salts or complexes. Benzotriazole and/or alkylaminotriazole are particularly preferably used. 3-Amino-5-alkyl-1,2,4-triazoles or the physiologically acceptable salts thereof are preferably used according to the invention, these substances particularly preferentially being used in a concentration of 0.001 to 10 wt. %, preferably of 0.0025 to 2 wt. %, particularly preferably of 0.01 to 0.04 wt. %. Preferred acids for salt formation include hydrochloric acid, sulfuric acid, phosphoric acid, carbonic acid, sulfurous acid, organic carboxylic acids such as acetic, glycolic, citric and succinic acid. 5-Pentyl-, 5-heptyl-, 5-nonyl-, 5-undecyl,-, 5-isononyl-, 5-versatic-10-acid alkyl-3-amino-1,2,4-triazoles and mixtures of these substances are very particularly effective.

Disintegration of the prefabricated moldings can be facilitated by incorporating disintegration auxiliaries or “tablet disintegrants” into these preparations in order to shorten disintegration times. Tablet disintegrants or disintegration accelerators are taken to mean auxiliary substances which ensure the rapid disintegration of tablets in water or other media and the prompt release of the active ingredients.

These substances, known as disintegrants due to their mode of action, increase in volume on exposure to water, resulting in an increase of their own volume (swelling), as well as possibly also generation of pressure due to the release of gases, causing the tablet to break up into smaller particles. Disintegration auxiliaries which have long been known include carbonate/citric acid systems, it also being possible to use other organic acids. Swelling disintegration auxiliaries include synthetic polymers such as polyvinylpyrrolidone (PVP) or natural polymers or modified natural materials such as cellulose and starch and the derivatives thereof, alginates or casein derivatives.

Disintegration auxiliaries are preferably used in quantities of 0.5 to 10 wt. %, preferably of 3 to 7 wt. % and in particular of 4 to 6 wt. %, based on total weight of the preparation containing the disintegration auxiliary.

Perfume oils or scents which may be used include individual fragrance compounds, for example, synthetic products of the ester, ether, aldehyde, ketone, alcohol and hydrocarbon type. Preferably, however, mixtures of various fragrances are used which together produce an attractive scent note. Such perfume oils may also contain natural fragrance mixtures, as are obtainable from plant sources, for example pine, citrus, jasmine, patchouli, rose or ylang-ylang oil.

The scents may be directly processed, but it may also be advantageous to apply the scents onto carriers which ensure a long-lasting scent thanks to slower scent release. Cyclodextrins have, for example, proved to be effective such carrier materials, it being also possible to coat the cyclodextrin-perfume complexes with further auxiliary substances.

Preferred dyes, the selection of which will cause the person skilled in the art no difficulty, have elevated storage stability and are insensitive to other ingredients in the agents and to light and have no marked substantivity relative to the substrates treated with the dye-containing preparations (e.g., textiles, glass, ceramics or plastic crockery) so as not to dye these substrates.

When selecting the dye preparation, care must be taken to ensure that the dye preparation has elevated storage stability and insensitivity to light. Further, when selecting suitable dye preparations, dye preparations have different stabilities with regard to oxidation. In general, water-insoluble dye preparations are more stable with regard to oxidation than water-soluble dye preparations. The concentration of the dye preparation in the washing or cleaning agents varies as a function of solubility and thus also of oxidation sensitivity. In the case of readily water-soluble dye preparations, dye preparation concentrations which are selected are typically in the range from a few 10⁻² to 10⁻³ wt. %. In the case of pigment dyes which are particularly preferred due to their brightness but are nonetheless less readily water-soluble, the suitable concentration of the dye preparation in washing or cleaning agents is in contrast typically a few 10⁻³ to 10⁻⁴ wt. %.

Preferred dye preparations include those which may be oxidatively destroyed in the washing process as well as mixtures thereof with suitable blue dyes, known as “blue toners”. It has proven advantageous to use dye preparations which are soluble in water or at room temperature in liquid organic substances. Examples of suitable dye preparations are anionic dye preparations, for example anionic nitroso dyes.

In addition to substances with a washing and cleaning action, preferred automatic dishwashing agent tablets contain a binder. It is particularly preferably for such a binder to be integrated into the tablet phase A of the dishwashing agent tablet. Preferred binders include organic materials such as (modified) celluloses and starches. However, nonionic polymers, preferably polyethylene glycols, or polyvinylpyrrolidones are particularly preferably used as binders.

Dishwashing agent tablets wherein the tablet phase A contains a nonionic polymer, preferably a polyalkylene glycol nonionic polymer, are preferred according to the invention. The amount of polyethylene glycol relative to total weight of tablet phase A is preferably from 0.1 to 10 wt. %, preferably 0.1 to 5 wt. % and in particular 0.1 to 3 wt. %.

The following table shows some example formulations of preferred binder-containing tablet phases A:

| | Formulation | Formulation | Formulation | Formulation 28 |
|---|---|---|---|---|
| Ingredient | 25 [wt. %] | 26 [wt. %] | 27 [wt. %] | [wt. %] |
| Citrate | 5 to 50 | 10 to 45 | 15 to 40 | 15 to 40 |
| Citric acid | 2 to 15 | 2 to 15 | 2 to 15 | 5 to 12 |
| Copolymer¹ | 0.1 to 40 | 0.2 to 20 | 0.5 to 15 | 1.0 to 10 |
| Polyethylene | 0.1 to 5 | 0.1 to 5 | 0.1 to 5 | 0.1 to 3 |
| glycol | | | | |
| Misc. | Ad 100 | Ad 100 | Ad 100 | Ad 100 |

¹Copolymer(s) comprising i) monomers containing acid groups ii) further nonionic monomers

The dishwashing agent tablets are preferably produced in a manner known to a person skilled in the art by press-molding particulate premixes. Preferably the particulate premix exhibits an average particle size of from 0.4 to 3.0 mm, preferably from 0.6 to 2.5 mm, and particularly from 0.8 to 2.0 mm.

Tableting, during which the particulate premix is compacted in a “die” between two punches to yield a solid compressed tablet, is divided into four sections or steps: apportioning, compaction (elastic deformation), plastic deformation and discharge. Tableting here preferably proceeds on “rotary presses”.

When tableting using rotary presses it has proved advantageous to carry out the tableting with the least possible fluctuations in tablet weight. In this way, tablet hardness fluctuations can also be reduced. Small weight fluctuations may be achieved in the following way—

use of plastics inserts with small thickness tolerances

low rotor rotational speed

large feed shoes

matching of the rotational speed of the feed shoe blade to the rotational speed of the rotor

feed shoe with constant powder level

decoupling of feed shoe and powder supply.

Any non-stick coating known from the art may be used to reduce punch fouling. Plastics coatings, plastics inserts or plastics punches are particularly advantageous. Rotating punches have also proven advantageous, with upper and lower punches being made rotatable depending on the options available. In the case of rotating punches, it is generally possible to dispense with a plastics insert. In this case, the punch surfaces should be electropolished.

Methods preferred according to the present invention are characterized in that press-molding proceeds at molding pressures of 0.01 to 50 kNcm⁻², preferably 0.1 to 40 kNcm⁻² and in particular 1 to 25 kNcm².

The density of dishwashing agent tablets preferred according to the invention is from 1.1 to 1.8 g/cm³, preferably from 1.2 to 1.7 g/cm³ and in particular from 1.3 to 1.6 g/cm³.

The present application accordingly also provides a method of producing a dishwashing agent tablet, wherein a particulate premix comprising—

a) 5 to 50 wt. % of citrate;

b) 1 to 20 wt. % of citric acid; and

c) 0.1 to 40 wt. % of anionic polymer(s)

is produced and press-molded to form a tablet.

In order to increase throughput, rotary presses may also be provided with two feed shoes, as a result of which it is then only necessary to execute a half rotation to produce a tablet.

As initially mentioned, for the purposes of the present invention, the tablets may likewise be of multiphase, in particular multilayer, structure. The moldings may here be manufactured in a predetermined three-dimensional shape and predetermined size. Three-dimensional shapes which may be considered include virtually any developments which can sensibly be handled, thus for example slabs, rods or bars, cubes, cuboids and corresponding three-dimensional elements with planar side faces and in particular cylindrical developments with a circular or oval cross-section. This final development here includes presentations ranging from a tablet up to compact cylindrical pieces with a ratio of height to diameter of above 1.

Bi- and multilayer moldings are produced by arranging two or more feed shoes in succession, without the gently pressed first layer being ejected before further filling. In this manner, it is possible by suitable process control also to produce jacketed and bull's eye tablets, which have an onion skin type structure, in which in the case of bull's eye tablets the upper side of the core or of the core layers is not covered and thus remains visible. Recessed tablets which comprise a recess (a cavity open on one side defined by webs and a base area) on their upper side may furthermore also be produced.

Corresponding methods for producing a dishwashing agent tablet, wherein a particulate premix comprising—

a) 5 to 50 wt. % of citrate;

b) 1 to 20 wt. % of citric acid; and

c) 0.1 to 40 wt. % of anionic polymer(s)

is produced and press-molded to form a recessed tablet, are preferred according to the invention.

After press-molding, the washing and cleaning agent moldings exhibit elevated stability. The breaking strength of cylindrical moldings may be determined by measuring the diametral fracture stress parameter, which may be determined according to—

$$σ = \frac{2 P}{π Dt}$$

σ here denotes diametral fracture stress (DFS) in Pa, P is the force in N which gives rise to the pressure exerted on the molding which causes fracture of the molding, D is the diameter of the molding in meters and t is the height of the molding.

The present application furthermore provides a method of cleaning dishes in a dishwashing machine using automatic dishwashing agent tablets according to the invention, the automatic dishwashing agent tablets preferably being dispensed into the interior of a dishwashing machine during the performance of a dishwashing program, before the start of the main washing cycle or in the course of the main washing cycle. Dispensing or introduction of the agent according to the invention into the interior of the dishwashing machine may proceed manually, but the agent is preferably dispensed into the interior of the dishwashing machine by means of the dispensing chamber of the dishwashing machine. Preferably, no additional water softener and no additional rinse aid is dispensed into the interior of the dishwashing machine in the course of the cleaning method. The present application also provides a kit for a dishwashing machine, comprising—
a) an automatic dishwashing agent tablet according to the invention;
b) instructions which instruct the consumer to use the automatic dishwashing agent without addition of a rinse aid and/or a water-softening salt.

Automatic dishwashing agents according to the invention exhibit their advantageous cleaning characteristics in particular in low temperature cleaning methods. Preferred dishwashing methods using agents according to the invention are carried out at temperatures of up to at most 55° C., preferably up to at most 50° C.

### EXAMPLES

In each case 20 g of three different particulate premixes were press-molded with a pressing force of 50 kN to form tablets weighing 20 g.

The following table shows the composition of the particular premixes—

| Raw material | Comparison 1 | Comparison 2 | Invention 1 |
|---|---|---|---|
| Phosphonate | 1.94 | 1.94 | 1.94 |
| Nonionic surfactant | 5.66 | 5.66 | 5.66 |
| Sodium citrate dihydrate | 22.39 | 22.39 | 22.39 |
| Citric acid anhydrate | 5.76 | 5.76 | 5.76 |
| Soda | 32.36 | 32.36 | 32.36 |
| Sodium percarbonate | 17.04 | 17.04 | 17.04 |
| TAED | 4.17 | 4.17 | 4.17 |
| Polyacrylic acid¹ | 9.06 | — | — |
| Polysulfonic acid² | — | 9.06 | — |
| Anionic polymer³ | — | — | 9.06 |
| Misc. | Ad 100 | Ad 100 | Ad 100 |

¹Polyacrylic acid, sodium salt
²Copolymer containing sulfonic acid groups but without nonionic monomers, sodium salt
³Anionic polymer, sodium salt, comprising i) monomers containing acid groups ii) further nonionic monomers.

Breaking hardness of the resultant tablets was determined. The results are stated in the following table (the stated values are averages from 10 tests)—

| | Comparison 1 | Comparison 2 | Invention 1 |
|---|---|---|---|
| Tablet hardness [N] | 224 | 245 | 301 |

As is clear from these results, hardness of a tablet containing citrate and citric acid may be markedly improved by addition of hydrophobically modified anionic copolymers.

We claim:

1. Mono- or multiphase automatic dishwashing agent tablet made from press-molded particulate material, wherein at least one tablet phase A comprises, based on total weight of phase A:
a) 5 to 50 wt. % of citrate
b) 1 to 20 wt. % of citric acid
c) 0.1 to 40 wt. % of anionic polymer(s), comprising
i) monomers containing acid groups
ii) further nonionic monomers.

2. Dishwashing agent tablet according to claim 1, wherein tablet phase A comprises 10 to 45 wt. % citrate, based on total weight of tablet phase A.

3. Dishwashing agent tablet according to claim 1, wherein tablet phase A comprises 2 to 15 wt. % citric acid, based on total weight of tablet phase A.

4. Dishwashing agent tablet according to claim 1, wherein the weight ratio of citrate to citric acid in tablet phase A is from to 40:1 to 2:1.

5. Dishwashing agent tablet according to claim 1, wherein tablet phase A comprises 0.2 to 20 wt. % anionic polymer, based on total weight of tablet phase A.

6. Dishwashing agent tablet according to claim 1, wherein the anionic polymer is a homo- or copolymer of a carboxylic acid.

7. Dishwashing agent tablet according to claim 1, wherein the anionic polymer is a copolymer formed from at least:
i) one or more monomers containing carboxylic acid groups;
ii) one or more monomers containing sulfonic acid groups; and
iii) one or more nonionogenic monomers.

8. Dishwashing agent tablet according to claim 1, wherein tablet phase A further comprises less than 20 wt % of phosphate, based on total weight of tablet phase A.

9. Dishwashing agent tablet according to claim 1, wherein tablet phase A further comprises from 1 to 60 wt. % carbonate, based on total weight of tablet phase A.

10. Dishwashing agent tablet according to claim 1, wherein tablet phase A further comprises from 0.2 to 5 wt % of enzyme preparation(s), based on total weight of tablet phase A.

11. Dishwashing agent tablet according to claim 1, wherein tablet phase A further comprises from 1 to 20 wt. % of sodium percarbonate, based on total weight of tablet phase A.

12. Method for producing a dishwashing agent tablet comprising:
producing a particulate premix comprising
a) 5 to 50 wt. % of citrate;
b) 1 to 20 wt. % of citric acid; and
c) 0.1 to 40 wt. % of anionic polymer(s), and
press-molding the premix to form a tablet.

13. Method according to claim 12, the particulate premix having an average particle size of from 0.4 to 3.0 mm.

14. Method according to claim 12 further comprising adding the tablet to an automatic dishwashing machine and cleaning dishes in the dishwashing machine using the tablet.

15. Method according to claim 14, wherein no additional water softener and no additional rinse aid is dispensed into the interior of the dishwashing machine in the course of cleaning.
